(19) United States
(12) Patent Application Publication
(10) Pub. No.: US 2024/0262954 A1
(43) Pub. Date: Aug. 8, 2024

(54) THERMOPLASTIC POLYURETHANE WITH IMPROVED STAIN RESISTANCE

(71) Applicant: BASF SE, Ludwigshafen am Rhein (DE)

(72) Inventors: Sebastian Richter, Shanghai (CN); Yasuyuki Suzuki, Yokkaichi-shi (JP); Stephan Dohmen, Lemfoerde (DE); Shi Qing Guo, Shanghai (CN); Da Hai Yu, Shanghai (CN)

(73) Assignee: BASF SE, Ludwigshafen am Rhein (DE)

(21) Appl. No.: 18/561,186

(22) PCT Filed: May 9, 2022
(86) PCT No.: PCT/EP2022/062500

§ 371 Date: Nov. 15, 2023

(30) Foreign Application Priority Data
May 20, 2021 (WO) PCT/CN2021/094889

(51) Int. Cl. C08G 18/66; C08G 18/32; C08G 18/42; C08G 18/76; H04M 1/02

(52) U.S. Cl. CPC C08G 18/664; C08G 18/3206; C08G 18/4202; C08G 18/4225; C08G 18/4238; C08G 18/7671; H04M 1/0283

(57) ABSTRACT

A thermoplastic polyurethane (TPU) with high transparency and improved stain resistance is made. The process for producing a shaped body out of such a thermoplastic polyurethane is developed for consumer applications.

### TECHNICAL FIELD

The present invention relates to a thermoplastic polyurethane (TPU) with high transparency and improved stain resistance, the process for producing a shaped body comprising such a thermoplastic polyurethane and the use of such thermoplastic polyurethane.

### BACKGROUND

Demand exists for polymeric materials that are useful for making protective cases and other components or accessories for personal electronic devices such as smart phones, tablets, and handheld computers.

Some consumers prefer the look of protective cases that are relatively clear in appearance or that are lightly or brightly colored. Further, some consumers prefer the feel of protective cases that are relative soft to the touch without being sticky or tacky. Additionally, the focus for the development of suitable materials for protective cases turned recently towards achieving high stain resistance to avoid an unliked yellowish or brownish look of used covers already after a few weeks or month of using them. Thus, highly transparency and stain resistance are required, with simultaneous requirement for suitable hardness with otherwise good mechanical properties of materials.

Thermoplastic polyurethanes for various applications are known in principle from the prior art. By the variation in the feedstocks, it is possible to obtain different profiles of properties.

WO2018115460A1 discloses a thermoplastic polyurethane, obtainable or obtained by reacting a polyisocyanate composition, a chain extender, and polyol composition, wherein the polyol composition comprises at least one polyol (P1), which has a molecular weight MW in the range from 1500 to 2500 g/mol and has at least one aromatic polyester block (B1).

WO2019112757A1 discloses a thermoplastic polyurethane compositions made from the reaction product of an isocyanate component comprising hexamethylene-1,6-diisocyanate, a polyol component, and a chain extender component comprising an alkylene substituted spirocyclic compound to have a stain resistance as well as transparency.

It has not been disclosed in the prior art that a thermoplastic polyurethane with highly transparency and improved stain resistance, especially with improved stain resistance towards natural body liquid mimicked by artificial sebum and oleic acid solution staining.

### SUMMARY OF THE INVENTION

The aforementioned needs are met by one or more aspects of the present invention.

Surprisingly, it has been found that, by using a reactant of polyol mixture comprises a polyol (P1) with an average molecular weight (Mw) of from 500 to 3000 g/mol and having aromatic polyester block, and another aliphatic polyol, it is possible to provide thermoplastic polyurethane compounds and shaped body (SC) formed therefrom having enhanced resistance to staining while also exhibiting good transparency and other desirable properties.

Thus, an object of the present invention is to provide a thermoplastic polyurethane, obtainable or obtained by reacting at least the components of (a) at least one polyisocyanate composition, (b) at least one chain extender, and (c) a polyol mixture comprising a polyol (P1) which has a molecular weight (Mw) of from 500 to 3000 g/mol and at least one aromatic polyester block (B1), and another aliphatic polyol.

Another object of the present invention is to provide a process for producing a shaped body (SC) comprising the thermoplastic polyurethane.

Another object of the present invention is to provide a shaped body obtainable or obtained by the process.

A further object of the present invention is to provide a mobile phone cover made from the thermoplastic and the use of the thermoplastic polyurethane in consumer electronics applications as wrist bands, device surface coatings, packaging coatings, antenna, buttons, surfaces of gaming equipment and earphones.

### DETAILED DESCRIPTION OF THE INVENTION

In the first aspect, the present invention relates to a thermoplastic polyurethane, obtainable or obtained by reacting at least the following components
(a) at least one polyisocyanate composition,
(b) at least one chain extender, and
(c) a polyol mixture,
wherein the polyol mixture comprises a polyol (P1) which has an average molecular weight (Mw) in a range of from 500 to 3000 g/mol and has at least one aromatic polyester block (B1), and another aliphatic polyol.

According to the invention, the polyol mixture (c) comprises a polyol (P1) having a Mw in the range from 500 to 3000 g/mol, preferably from 500 to 1500 g/mol. In addition, the polyol (P1) has an aromatic polyester block (B1). In the context of the present invention, this is understood to mean that the aromatic polyester block (B1) may be a polyester of an aromatic dicarboxylic acid and an aliphatic diol or a polyester of an aliphatic dicarboxylic acid and an aromatic diol. Preferably, the aromatic polyester block (B1) in the context of the present invention is a polyester of an aromatic dicarboxylic acid and an aliphatic diol. Suitable aromatic dicarboxylic acids are, for example, terephthalic acid, isophthalic acid or phthalic acid, preferably terephthalic acid. Accordingly, suitable polyols (P1) in the context of the present invention are those that have, for example, at least one polyethylene terephthalate block or at least one polybutylene terephthalate block. Preferably, the aromatic polyester block (B1) is prepared from a corresponding polyester structure through glycolysis during the synthesis of the polyol (P1) in order to assure a sufficient block length of the repeat units of the aromatic systems. The preferred aromatic block length is determined by in average 2 to 3 aromatic repeating units.

According to the invention, the thermoplastic polyurethane may especially be a compact thermoplastic polyurethane. Accordingly, the present invention, in a further embodiment, relates to a thermoplastic polyurethane as described above, wherein the thermoplastic polyurethane is a compact thermoplastic polyurethane.

In a further embodiment, the present invention accordingly relates to a thermoplastic polyurethane as described above, wherein the aromatic polyester block (B1) is a polyester of an aromatic dicarboxylic acid and an aliphatic diol. In a further embodiment, the present invention also relates to a thermoplastic polyurethane as described above, wherein the aromatic polyester block (B1) is a polyethylene terephthalate block or a polybutylene terephthalate block. In a further preferred embodiment, the present invention further relates to a thermoplastic polyurethane as described above, wherein the aromatic polyester block (B1) is a polyethylene terephthalate block.

It has been found that, surprisingly, the use of a polyol mixture comprising at least a polyol (P1) having a Mw in the range from 500 to 3000 g/mol and having at least one aromatic polyester block (B1), and another aliphatic polyol afford thermoplastic polyurethanes that have very good stain resistance towards nature body liquids as well as suitable hardness of Shore A 80 to Shore D 70.

In the context of the present invention, suitable polyols (P1) are especially those that are based on aromatic polyesters, such as polybutylene terephthalate (PBT) or polyethylene terephthalate (PET). Preferably, the polyol (P1) is prepared here by reacting the aromatic polyester with dicarboxylic acids and diols to give mixed aromatic/aliphatic polyester diols. For example, it is possible in the context of the present invention to react the aromatic polyester in solid or liquid form with dicarboxylic acids and diols. According to the invention, the aromatic polyester used typically has a higher molecular weight than the blocks (B1) present in the polyol (P1).

Polyester polyols (P1) suitable in accordance with the invention typically comprise 20% to 70% by weight, preferably 30% to 60% by weight, more preferably 35% to 55% by weight, of the aromatic polyester blocks (B1), based in each case on the overall polyester polyol (P1). In a further embodiment, the present invention accordingly relates to a thermoplastic polyurethane as described above, wherein the polyol (P1) includes 20% to 70% by weight of the aromatic polyester blocks (B1), based on the overall polyester polyol (P1).

According to the invention, the polyol (P1) has a Mw in the range from 500 to 3000, preferably in the range from 500 to 2000, more preferably in the range from 500 to 1500. In a further embodiment, the present invention accordingly relates to a thermoplastic polyurethane as described above, wherein the polyol (P1) has a molecular weight Mw in the range from 500 to 3000 g/mol.

The average molecular weight (Mw) is calculated using the following formula, where z is the functionality of the polyester polyol and z=2:

Mw=1000 mg/g*[(z*56.106 g/mol)/(OHN [mg/g])]

In the preparation of the polyols (P1), preferably aromatic polyesters such as polybutylene terephthalate (PBT) or polyethylene terephthalate (PET) are used. Polyethylene terephthalate is a thermoplastic polymer prepared by polycondensation. The quality of the PET, and its physical properties such as toughness or durability, are dependent on the chain length. Older PET synthesis methods are based on the transesterification of dimethyl terephthalate with ethylene glycol. Nowadays, PET is synthesized almost exclusively by direct esterification of terephthalic acid with ethylene glycol. In the same way, terephthalic acid can also be reacted with butane1,4-diol to give polybutylene terephthalate (PBT). This likewise thermoplastic polymer is available under brands such as CRASTIN® (DuPont), POCAN® (Lanxess), ULTRADUR® (BASF) or ENDURAN® (SABIC IP) and VESTODUR® (Evonik). Its chemical and physical/technical properties correspond largely to those of PET.

According to the invention, it is also possible to use aromatic polyesters such as polybutylene terephthalate (PBT) or polyethylene terephthalate (PET) that are obtained from recycling processes. For example, polyethylene terephthalate can be used in the form of flakes that are obtained from plastic recycling processes. Materials of this kind typically have molecular weights of about 12,000 g/mol.

According to the invention, suitable polyols (P1) can also be obtained using aromatic polyesters such as polybutylene terephthalate or polyethylene terephthalate with higher molecular weight and diols by transesterification. Suitable reaction conditions are known per se to those skilled in the art.

In addition, in the preparation of the polyols (P1), especially diols having 2 to 10 carbon atoms, for example ethanediol, propanediol, butanediol, pentanediol, hexanediol or di- or triethylene glycol, further preferably butanediol, hexanediol, diethylene glycol, or cyclic aliphatic diols such as cyclohexane dimethanol, or mixtures thereof, are used. It is also possible to use diols with more than 10 carbon atoms or short polyether diols, for example PTHF 250 or PTHF 650 or a short-chain polypropylene glycol such as a PPG 500. Dicarboxylic acids used may, for example, be linear or branched-chain diacids having 4 to 12 carbon atoms or mixtures thereof. Preference is given by using adipic acid, succinic acid, glutaric acid or sebacic acid or a mixture of the acids mentioned. Particular preference is given in the context of the present invention to adipic acid. According to the invention, in the preparation of the polyols (P1), it is also possible to use further polyester diols as feedstocks, for example butanediol adipate or ethylene adipate.

According to the invention, the polyol mixture (c) comprises another aliphatic polyol as well as the at least one polyol (P1). The aliphatic polyols preferably do not have any polyethylene terephthalate block. In another embodiment, the present invention accordingly provides a thermoplastic polyurethane as described above, wherein the polyol mixture comprises another aliphatic polyol selected from the group consisting of polyetherols, polyesterols, polycaprolactone alcohols and hybrid polyols.

Higher molecular weight compounds having hydrogen atoms reactive toward isocyanates that are used may be the commonly known polyols having compounds reactive toward isocyanates.

Polyols are fundamentally known to those skilled in the art and described for example in “Kunststoffhandbuch, Band 7, Polyurethane” [Plastics Handbook, volume 7, Polyurethanes], Carl Hanser Verlag, 3rd edition 1993, chapter 3.1. Particular preference is given to using polyesterols or polyetherols as polyols. Particular preference is given to polyester polyols. It is likewise possible to use polycarbonates. Copolymers may also be used in the context of the present invention. The number-average molecular weight of polyols used in accordance with the invention is preferably between 500 g/mol and 8000 g/mol, preferably between 600 g/mol and 5000 g/mol, especially between 800 g/mol and 3000 g/mol.

They preferably have an average functionality with respect to isocyanates of 1.8 to 2.3, more preferably 1.9 to 2.2, especially 2.

Polyetherols used in the invention may be polyethylene glycols, polypropylene glycols and polytetrahydrofurans (PTHF). According to the invention, various other aliphatic polyetherols are suitable.

Preferred polyesterols used may be polyesterols based on aliphatic diacids and diols. Diols used are preferably diols having 2 to 12 carbon atoms, for example ethanediol, propanediol, butanediol, pentanediol, hexanediol or di- or triethylene glycol, especially butane-1,4-diol or mixtures thereof. Diacids used may be any known diacids, for example linear or branched-chain diacids having 4 to 12 carbon atoms or mixtures thereof. Preference is given to using adipic acid as diacid.

In a particularly preferred embodiment, the polyol is a polyesterol based on adipic acid and 1,4-butanediol or mixtures of 1,4-butanediol with ethylene glycol having a molecular weight in the Mw range of 800 g/mol to 3500 g/mol.

According to the invention, various other polyesters, block copolymers and hybrid polyols, for example poly(ester/amide), are also usable.

Preferably, the polyols used have an average functionality between 1.8 and 2.3, preferably between 1.9 and 2.2, especially 2. Preferably, the polyols used in accordance with the invention have solely primary hydroxyl groups.

According to the invention, the polyol may be used in pure form or in the form of a composition comprising the polyol and at least one solvent. Suitable solvents are known per se to the person skilled in the art.

The polyol (P1) is preferably used in a weight ratio in the range from 95:5 to 5:95 to the aliphatic polyol. In further-preferred embodiments, the polyol (P1) and the aliphatic polyol are used in a weight ratio in the range from 75:25 to 5:95, further preferably in the range from 50:50 to 10:90.

It is essential in the context of the present invention that, in the preparation of the thermoplastic polyurethane, at least one chain extender (b) and the polyol mixture (c) as described above are used.

According to the invention, it is possible to use one chain extender, but it is also possible to use mixtures of different chain extenders.

Chain extenders used in the context of the present invention may, for example, be compounds having hydroxyl or amino groups, especially having 2 hydroxyl or amino groups. According to the invention, however, it is also possible that mixtures of different compounds are used as chain extenders. According to the invention, the average functionality of the mixture is 2.

Preference is given in accordance with the invention to using compounds having hydroxyl groups as chain extenders, especially diols. It is preferably possible to use aliphatic, araliphatic, aromatic and/or cycloaliphatic diols having a molecular weight of 50 g/mol to 350 g/mol.

Preference is given to alkanediols having 2 to 12 carbon atoms in the alkylene chain, especially di-, tri-, tetra-, penta-, hexa-, hepta-, octa-, nona-, deca-, unodeca-, and/or dodeca-alkylene glycols. For the present invention, particular preference is given to 1,2-ethylene glycol, propane-1,3-diol, butane-1,4-diol, hexane-1,6-diol and 1,4-Cyclohexanedimethanol. It is also possible to use aromatic compounds such as hydroxyquinone bis(2hydroxyethyl) ether.

According to the invention, it is also possible to use compounds having amino groups, for example diamines. It is likewise possible to use mixtures of diols and diamines.

The chain extender is preferably a diol having a molecular weight Mw<350 g/mol. According to the invention, it is possible that only one diol having a molecular weight Mw<350 g/mol is used for preparation of the transparent thermoplastic polyurethane.

In a further embodiment, more than one diol is used as chain extender. It is thus also possible to use mixtures of chain extenders, where at least one diol has a molecular weight Mw<350 g/mol. If more than one chain extender is used, the second or further chain extender may also have a molecular weight of Mw<350 g/mol.

In a further embodiment, the chain extender is selected from the group consisting of butane-1,4-diol and hexane-1,6-diol or butane-1,4-diol and propane-1,3-diol.

In a further embodiment, the present invention accordingly relates to a thermoplastic polyurethane as described above, wherein the chain extender used in (b) is a diol having a molecular weight Mw<350 g/mol.

The chain extender, especially the diol having a molecular weight Mw<350 g/mol, is preferably used in a molar ratio in the range from 40:1 to 1:10 relative to the polyol mixture (c). Preferably, the chain extender and the polyol mixture are used in a molar ratio in the range from 20:1 to 1:9, further preferably in the range from 10:1 to 1:5,

In a further embodiment, the present invention accordingly relates to a thermoplastic polyurethane as described above, wherein the chain extender used in (b) and the polyol mixture (c) present in the polyol composition are used in a molar ratio of 40:1 to 1:10.

According to the invention, at least one isocyanate is used. According to the invention, it is also possible to use mixtures of two or more polyisocyanates.

Preferred polyisocyanates in the context of the present invention are diisocyanates, especially aliphatic or aromatic diisocyanates, further preferably aromatic diisocyanates.

In a further embodiment, the present invention accordingly relates to a thermoplastic polyurethane as described above, wherein the polyisocyanate is an aliphatic or aromatic diisocyanate.

In addition, in the context of the present invention, isocyanate components used may be prereacted prepolymers in which some of the OH components have been reacted with an isocyanate in a preceding reaction step. These prepolymers are reacted with the remaining OH components in a further step, the actual polymer reaction, and then form the thermoplastic polyurethane. The use of prepolymers makes it possible also to use OH components having secondary alcohol groups.

Aliphatic diisocyanates used are customary aliphatic and/or cycloaliphatic diisocyanates, for example tri-, tetra-, penta-, hexa-, hepta- and/or octamethylene diisocyanate, 2-methylpentamethylene 1,5-diisocyanate, 2-ethyltetramethylene 1,4-diisocyanate, hexamethylene 1,6-diisocyanate (HDI), pentamethylene 1,5-diisocyanate, butylene 1,4-diisocyanate, trimethylhexamethylene 1,6-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate, methylene dicyclohexyl 4,4′-, 2,4′- and/or 2,2′-diisocyanate (H12MDI).

Preferred aliphatic polyisocyanates are hexamethylene 1,6-diisocyanate (HDI), 1-isocyanato-3,3,5-trimethyl-5-isocyanatomethylcyclohexane and methylene dicyclohexyl 4,4′-, 2,4′- and/or 2,2′-diisocyanate (H12MDI); especially preferred are hexamethylene 1,6-diisocyanate (HDI), methylene dicyclohexyl 4,4′-, 2,4′- and/or 2,2′-diisocyanate (H12MDI) and 1-isocyanato-3,3,5-trimethyl-5-isocyanatomethylcyclohexane (IPDI) or mixtures thereof.

Suitable aromatic diisocyanates are especially diphenylmethane 2,2′-, 2,4′- and/or 4,4′-diisocyanate (MDI), naphthylene 1,5-diisocyanate (NDI), tolylene 2,4- and/or 2,6-diisocyanate (TDI), 3,3′-dimethyl-4,4′-diisocyanatodiphenyl (TODI), p-phenylene diisocyanate (PDI), diphenylethane 4,4′-diisocyanate (EDI), 1,3-Bis(isocyanatomethyl) benzene (XDI), diphenylmethane diisocyanate, dimethyl diphenyl 3,3′-diisocyanate, diphenylethane 1,2-diisocyanate and/or phenylene diisocyanate.

Particularly preferred isocyanates in the context of the present invention are diphenylmethane 2,2′-, 2,4′- and/or 4,4′-diisocyanate (MDI) and mixtures thereof.

Preferred examples of higher-functionality isocyanates are triisocyanates, e.g. triphenylmethane 4,4′,4″-triisocyanate, and also the cyanurates of the aforementioned diisocyanates, and the oligomers obtainable by partial reaction of diisocyanates with water, for example the biurets of the aforementioned diisocyanates, and also oligomers obtainable by controlled reaction of semi-blocked diisocyanates with polyols having an average of more than 2 and preferably 3 or more hydroxyl groups.

In a further embodiment, the present invention relates to a process as described above, wherein the polyisocyanate is an aliphatic diisocyanate.

According to the invention, the polyisocyanate may be used in pure form or in the form of a composition comprising the polyisocyanate and at least one solvent. Suitable solvents are known to those skilled in the art. Suitable examples are nonreactive solvents such as ethyl acetate, methyl ethyl ketone, tetrahydrofuran and hydrocarbons.

According to the invention, in the reaction of the at least one polyisocyanate composition, the at least one chain extender, and the polyol mixture, it is possible to add further feedstocks, for example catalysts or auxiliaries and additives.

Suitable auxiliaries and additives are known per se to those skilled in the art. Examples include surface-active substances, flame retardants, nucleating agents, oxidation stabilizers, antioxidants, lubricants and demolding aids, dyes and pigments, stabilizers, for example against hydrolysis, light, heat or discoloration, inorganic and/or organic fillers, reinforcers and plasticizers. Suitable assistants and additives may be found, for example in Kunststoffhandbuch [Plastics Handbook], volume VII, published by Vieweg and Höchtlen, Carl Hanser Verlag, Munich 1966 (p. 103-113).

Preference is further given to using at least one plasticizer.

Plasticizers used may be any of the plasticizers known for use in TPUs. These include, for example, compounds comprising at least one phenolic group. Such compounds are described in EP 1 529 814 A2. Moreover, it is also possible, for example, to use polyesters having a molecular weight of about 100 to 1500 g/mol based on dicarboxylic acid, benzoic acid and at least one di- or triol, preferably a diol. Diacid components used are preferably succinic acid, glutaric acid, adipic acid, suberic acid, azelaic acid, decanedicarboxylic acid, maleic acid, fumaric acid, phthalic acid, isophthalic acid and/or terephthalic acid, and diols used are preferably ethane-1,2-diol, diethylene glycol, propane-1,2-diol, propane-1,3-diol, dipropylene glycol, butane-1,4-diol, pentane-1,5-diol and/or hexane-1,6-diol. The ratio here of dicarboxylic acid to benzoic acid is preferably 1:10 to 10:1. Such plasticizers are described in detail, for example, in EP 1 556 433 A1. Particular preference is also given to plasticizers based on citric esters, especially triethyl citrate, triacetyl triethyl citrate, tri(n-butyl) citrate, acetyl tri(n-butyl) citrate and acetyl tri(2-ethylhexyl) citrate. Further preferred plasticizers are triacetin, diisononyl cyclohexane-1,2-dicarboxylate, 2,2,4-trimethylpentane-1,3-diol diisobutyrate, tri-2-ethylhexyl trimellitate, dibutoxyethyl phthalate, mixture of phenyl (C10-C21)alkanesulfonate, dipropylene glycol dibenzoate, tri-2-ethylhexyl tri mellitate, N-dodecyl-2-pyrrolidone, isodecyl benzoate, mixture of diphenyl cresyl phosphate 42-47%, triphenyl phosphate 20-24%, bis(methylphenyl) phenylphosphate 20-24% and tricresyl phosphate 4-6%, and diethylhexyl adipate, aliphatic fatty acid esters, triethylene glycol di(2-ethylhexanoate) and dioctyl terephthalate.

Suitable catalysts are likewise known in principle from the prior art. Suitable catalysts are for example organic metal compounds selected from the group consisting of tin, titanium, zirconium, hafnium, bismuth, zinc, aluminum and iron organyls, for example tin organyl compounds, preferably tin dialkyls such as tin(II) isooctoate, tin dioctoate, dimethyltin or diethyltin, or tin organyl compounds of aliphatic carboxylic acids, preferably tin diacetate, tin dilaurate, dibutyltin diacetate, dibutyltin dilaurate, titanate esters, bismuth compounds, such as bismuth alkyl compounds, preferably bismuth neodecanoate or similar, or iron compounds, preferably iron(III) acetylacetonate.

In a preferred embodiment the catalysts are selected from tin compounds and bismuth compounds, more preferably tin alkyl compounds or bismuth alkyl compounds. Tin(II) isooctoate and bismuth neodecanoate are particularly suitable.

The catalysts are typically employed in amounts of 3 ppm to 2000 ppm, preferably 10 ppm to 1000 ppm, more preferably 20 ppm to 500 ppm and most preferably 30 ppm to 300 ppm.

According to the invention, the thermoplastic polyurethane has a total transmittance of higher than 86% according to the test standard DIN 11664-4.

According to the invention, the thermoplastic polyurethane has a hardness of from Shore A hardness 80 to Shore D 70, preferably from Shore A85 to Shore D 70, according to the test standard DIN ISO 7619-1.

According to the invention, the staining of the thermoplastic polyurethane after treatment in oleic acid for 16 hours at 55° C. results in delta E values<7 and/or after treatment in an artificial sebum solution for 7 days at 55° C. results in delta E values<1.2 according to the test standard ASTM E313.

In a further aspect, the present invention also relates to a process for producing a shaped body (SC) comprising the following steps:
(A) preparing a thermoplastic polyurethane comprising the reaction of
(a) at least one polyisocyanate composition,
(b) at least one chain extender, and
(c) a polyol mixture,
wherein the polyol mixture comprises a polyol (P1) which has a molecular weight Mw in the range from 500 to 3000 g/mol and has at least one aromatic polyester block (B1), and another aliphatic polyol; and
(B) producing a shaped body (SC) from the thermoplastic polyurethane.

The process of the invention comprises steps (A) and (B). First of all, in step (A), a thermoplastic polyurethane is prepared by reacting at least one polyisocyanate composition, at least one chain extender and a polyol mixture. According to the invention, this polyol mixture comprises at least one polyol (P1) which has a molecular weight Mw in the range from 500 to 3000 g/mol and has at least one aromatic polyester block (B1) as defined above, especially a polyethylene terephthalate block, and another aliphatic polyol.

In step (B), a shaped body (SC) is produced from the thermoplastic polyurethane obtained in step (A). In the context of the present invention, the shaped body (SC) may also, for example, be a foil. In the context of the present invention, the shaped body (SC) can be produced by all customary methods, for example by extrusion, injection molding or sintering methods or from solution.

In a further embodiment, the present invention accordingly relates to a process as described above, wherein the shaped body (SC) is produced in step (b) by means of extrusion, injection molding or sintering methods or from solution.

The process in step (A) can in principle be conducted under the reaction conditions that are known per se.

In a preferred embodiment, the process in step (A) is conducted at elevated temperatures relative to ambient temperature, further preferably in the range between 50° C. and 200° C., more preferably in the range from 55° C. to 150° C., especially in the range from 60° C. to 120° C.

According to the invention, the heating can be effected in any suitable manner known to the person skilled in the art, preferably by electrical heating, heating via heated oil, heated polymer fluids or water, induction fields, hot air or IR radiation.

The resultant thermoplastic polyurethanes are processed in accordance with the invention to give a shaped body (SC). The process accordingly comprises step (A) and step (B). According to the invention, the process may comprise further steps, for example thermal treatments.

By the process of the invention, a shaped body (SC) is obtained, which, with highly transparency and improved stain resistance, especially with improved stain resistance towards natural body liquid mimicked by artificial sebum and oleic acid solution staining. In a further aspect, the present invention also relates to shaped bodies obtainable or obtained by a process as described above.

According to the invention, the shaped body could be a mobile phone cover. In a further aspect, the present invention also relates to a mobile phone cover made from the thermoplastic polyurethane as described above.

According to the invention, the thermoplastic polyurethane described as above could be used in consumer electronics applications as wrist bands, device surface coatings, packaging coatings, antenna, buttons, surfaces of gaming equipment and earphones.

Further embodiments of the present invention are apparent from the claims and the examples. It will be appreciated that the features of the subject matter/processes/uses according to the invention that are recited hereinabove and elucidated hereinbelow are usable not only in the combination specified in each case but also in other combinations without departing from the scope of the invention. For example, the combination of a preferred feature with a particularly preferred feature or of a feature not characterized further with a particularly preferred feature etc. is thus also encompassed implicitly even if this combination is not mentioned explicitly.

### Examples

### Measuring and Test Methods

The measuring and test methods are shown in Table 1.

TABLE 1

| Property | Unit | Testing standard |
|---|---|---|
| Viscosity | mPas | DIN EN ISO 3219 (version Jan. 10, 1994) |
| Hydroxyl | mg KOH/g | DIN 53240 (version Jan. 12, 1971) |
| number | | |
| Acid number | mg KOH/g | DIN EN 1241 (version Jan. 5, 1998) |
| Hardness | Shore A or | DIN ISO 7619-1 |
| | Shore D | |
| Transparency | % | DIN 11664-4 |
| ΔE | — | ASTM E313 |

Moreover, the sebum and oleic acid solution staining is measured as follows:

Oleic acid test: The test plates have been immersed into an oleic acid solution (cis-Oleic acid, AR 500 mL from Sinopharm Chemical Reagent Co., Ltd.) at 55° C. for 16 hours or 7 days, respectively. Afterwards the samples have been rinsed to remove the oleic acid from the surface and used for ΔE measurements.

Sebum test: The test plates have been immersed into an artificial sebum solution (Artificial Sebum, ZW-PZ-250L, prepared according to ASTMD 4265-14 or 4265-98 from Shenzhen Zhongwei equipment co., Ltd.) at 55° C. for 7 days. Afterwards the samples have been rinsed to remove the oleic acid from the surface and used for ΔE measurements.

### Materials

The materials used in the examples are as follows.

| | |
|---|---|
| Polyol 1: | Polyester polyol based on adipic acid and 1,4-butanediol |
| | with an OH-Number of 56, functionality: 2 |
| Polyol 2: | Polyester polyol based on adipic acid, PET, 1,4- |
| | butanediol and 1,3-pro-panediol with an OH-Number of |
| | 112, functionality: 2 |
| Isocyanate 1: | 4,4′-Methylene diphenyl diisocyanate |
| Chain | 1,4- Butanediol |
| extender 1: | |
| Stabilizer 1: | Hydrolysis stabilizer based on polycarbodiimide |
| Stabilizer 2: | Sterically hindered amin |
| Stabilizer 3: | Sterically hindered phenol |
| Stabilizer 4: | Oxanilide |
| Additive 1: | Montanic acid ester |

### Synthesis of the Polyester Polyol Containing Aromatic Blocks

### Synthesis of Polyol 2

788.52 g adipic acid, 309.27 g 1,3-propanediol (3% excess) and 366.24 g 1,4-butanediol (3% excess) were added into a 4000 ml round shaped flask equipped with a thermocouple PT100, nitrogen inlet, stirrer, convoy, distillation tower and heating device. The mixture was heated to 120° C. until a homogeneous solution was obtained. 1250 g polyethylene terephthalate (PET) flakes were then added into this mixture and subsequently 10 ppm=2,5 g TTB (tetra-n-butyl orthotitanate 1% in toluene) was added. The reaction mixture was stirred for 1.5 hours at 180° C. and subsequently heated to 240° C. The formed water was continuously removed from the reaction vessel. During the synthesis, the PET flakes are observed to be decomposed until a clear solution is obtained. This transparent solution is further condensed until a product with an acid number<1.0 mg KOH/g is obtained.
The final product is characterized by the following specifications:
OH-number 112 mg KOH/g
Acid number 0.38 mg KOH/g
Viscosity at 75° C.: 1803 mPas

### General Procedure of TPU Synthesis

The polyols from table 2 were heated to 80° C. and subsequently mixed with other reactants listed in table 2. The mixture was stirred until it reached 110° C. and afterwards casted into a mold which was heated to 125° C. The casted slap was annealed for 15 hours at 80° C. and subsequently granulated in a cutting mill. The granules were used to produce 2 mm thick test plates via injection molding. These test plates have been used to measure mechanical properties summarized in table 3.

TABLE 2
Recipes of the synthesized TPU samples

| | Comparison | Example | Example | Example | Example | Example | Comparison |
|---|---|---|---|---|---|---|---|
| | 1 | 1 | 2 | 3 | 4 | 5 | 2 |
| Polyol 1 [g] | 850.00 | 807.50 | 765.00 | 637.50 | 400.00 | 212.50 | — |
| Polyol 2 [g] | — | 42.50 | 85.00 | 212.50 | 400.00 | 637.50 | 780.00 |
| Chain extender | 168.77 | 169.72 | 170.68 | 173.54 | 167.82 | 183.07 | 172.37 |
| 1 [g] | | | | | | | |
| Isocyanate 1 | 576.47 | 584.52 | 592.57 | 616.72 | 618.33 | 697.22 | 676.74 |
| [g] | | | | | | | |
| Stabilizer 1 [g] | 3.40 | 3.40 | 3.40 | 3.40 | 3.20 | 3.40 | 3.12 |
| Stabilizer 2 [g] | 3.22 | 3.24 | 3.26 | 3.31 | 3.20 | 3.50 | 3.29 |
| Stabilizer 3 [g] | 3.22 | 3.24 | 3.26 | 3.32 | 3.20 | 3.50 | 3.30 |
| Stabilizer 4 [g] | 4.03 | 4.05 | 4.07 | 4.14 | 4.01 | 4.37 | 4.11 |
| Additive 1 [g] | 2.42 | 2.43 | 2.44 | 2.49 | 2.40 | 2.62 | 2.47 |
| Index | 1000 | 1000 | 1000 | 1000 | 1000 | 1000 | 1000 |
| Hard phase | 40.0 | 40.0 | 40.0 | 40.0 | 40.0 | 40.0 | 40.0 |
| content [%] | | | | | | | |

TABLE 3
Properties of the used examples

| | Comparison | Example | Example | Example | Example | Example | Comparison |
|---|---|---|---|---|---|---|---|
| | 1 | 1 | 2 | 3 | 4 | 5 | 2 |
| | Ester:PET | Ester:PET | Ester:PET | Ester:PET | Ester:PET | Ester:PET | Ester:PET |
| | polyol | polyol | polyol | polyol | polyol | polyol | polyol |
| | 100:0 | 95:5 | 90:10 | 75:25 | 50:50 | 25:75 | 0:100 |
| Transparency | 88 | 89 | 89 | 89 | 88 | 87 | 86 |
| [%] | | | | | | | |
| Hardness | Shore | Shore | Shore | Shore | Shore | Shore | Shore |
| | A 94 | A 94 | A 95 | A 96 | D 59 | D 68 | D 79 |
| ΔE after | 7.61 | 6.51 | 4.58 | 3.78 | 1.9 | 1.16 | 0.83 |
| oleic acid | | | | | | | |
| test 16 h | | | | | | | |
| ΔE after | 29.38 | 26.82 | 25.59 | 23.86 | 10.02 | 6.26 | 1.78 |
| oleic acid | | | | | | | |
| test 7 d | | | | | | | |
| ΔE after | 1.25 | 1.07 | 0.79 | 0.68 | 0.65 | 0.6 | 0.24 |
| artificial | | | | | | | |
| sebum test | | | | | | | |
| 7 d | | | | | | | |

As can be seen from the above table 3, comparative Example 1 (prepared with no PET segment contained polyol) shows worse stain resistant property with higher ΔE value. In contrast, Example 1 to Example 5 show improved stain resistant property. Comparative Example 2 (prepared with solo PET segment contained polyol) though have better stain resistant property, it does not have good transparency and the hardness is too high for some specific use such as mobile phone cover.

The structures, materials, compositions, and methods described herein are intended to be representative examples of the invention, and it will be understood that the scope of the invention is not limited by the scope of the examples. Those skilled in the art will recognize that the invention may be practiced with variations on the disclosed structures, materials, compositions and methods, and such variations are regarded as within the ambit of the invention. Thus, it is intended that the present invention cover such modifications and variations as come within the scope of the appended claims and their equivalents.

1. A thermoplastic polyurethane, obtainable or obtained by reacting at least the following components
(a) at least one polyisocyanate composition,
(b) at least one chain extender, and
(c) a polyol mixture,
wherein the polyol mixture comprises a polyol (P1) which has a molecular weight Mw in a range of from 500 to 3000 g/mol and has at least one aromatic polyester block (B1), and another aliphatic polyol.

2. The thermoplastic polyurethane according to claim 1, wherein the polyol (P1) has a molecular weight Mw in a range of from 700 to 2500 g/mol.

3. The thermoplastic polyurethane according to claim 1, wherein the at least one aromatic polyester block (B1) comprises:
a polyethylene terephthalate block or a polybutylene terephthalate block.

4. The thermoplastic polyurethane according to claim 1, wherein the at least one aromatic polyester block (B1) comprises a polyethylene terephthalate.

5. The thermoplastic polyurethane according to claim 1, wherein the another aliphatic polyol is at least one selected from the group consisting of a polyetherol, a polyesterol, a polycarbonate alcohol and a hybrid polyol.

6. The thermoplastic polyurethane according to claim 1, wherein the another aliphatic polyol is at least one selected from the group consisting of a polyesterol and a polycarbonate diol.

7. The thermoplastic polyurethane according to claim 1, wherein the at least one polyisocyanate composition comprises;
at least one selected from the group consisting of an aliphatic and aromatic diisocyanate.

8. The thermoplastic polyurethane according to claim 7, wherein the aliphatic polyisocyanate composition comprises:
4,4-methylenedicyclohexyl diisocyanate, 2,4-methylenedicyclohexyl diisocyanate and/or 2,2′-methylenedicyclohexyl diisocyanate (H12-MDI).

9. The thermoplastic polyurethane according to claim 7, wherein the aromatic polyisocyanate composition comprises;
2,2′-diphenylmethane diisocyanate, 2,4′-diphenylmethane diisocyanate, and/or 4,4-diphenylmethane diisocyanate (MDI).

10. The thermoplastic polyurethane according to claim 1, wherein the polyol (P1) and the another aliphatic polyol present in the polyol composition are used in a weight ratio of from 95:5 to 5:95.

11. The thermoplastic polyurethane according to claim 1, wherein the total transmittance of the thermoplastic polyurethane is higher than 86% according to the test standard DIN 11664-4.

12. The thermoplastic polyurethane according to claim 1, wherein the hardness of the thermoplastic polyurethane is from Shore A hardness 80 to Shore D 70 according to the test standard DIN ISO 7619-1.

13. The thermoplastic polyurethane according to claim 1, wherein the staining of the thermoplastic polyurethane after treatment in oleic acid for 16 hours at 55° C. results in deltaE values<7 according to the test standard ASTM E313.

14. The thermoplastic polyurethane according to claim 1, wherein the staining of the thermoplastic polyurethane after treatment in artificial sebum solution for 7 days at ° C. results in deltaE values<1.2 according to the test standard ASTM E313.

15. A process for producing a shaped body (SC) comprising:
(A) preparing a thermoplastic polyurethane, the preparing comprising the reaction of
(a) at least one polyisocyanate composition,
(b) at least one chain extender, and
(c) a polyol mixture,
wherein the at least polyol mixture comprises a polyol (P1) which has a molecular weight Mw in a range of from 500 to 3000 g/mol and has at least one aromatic polyester block (B1), and another aliphatic polyol; and
(B) producing a shaped body (SC) from the thermoplastic polyurethane.

16. The process according to claim 15, wherein the shaped body (SC) of (B) is produced by extrusion, injection molding or sintering methods or from solution.

17. The shaped body obtainable or obtained by the process according to claim 15.

18. The shaped body according to claim 17, wherein the shaped body is a mobile phone cover.

19. A mobile phone cover made from the thermoplastic polyurethane according to claim 1.

20. A consumer electronics application, comprising:
the thermoplastic polyurethane according to claim 1; wherein the consumer electronics applications as is at least one selected from the group consisting of wrist bands, device surface coatings, packaging coatings, antenna, buttons, surfaces of gaming equipment and earphones.
